(19) United States
(12) Patent Application Publication
(10) Pub. No.: US 2023/0261872 A1
(43) Pub. Date: Aug. 17, 2023

(54) UNIVERSAL ZERO-KNOWLEDGE SUCCINCT NON-INTERACTIVE ARGUMENT OF KNOWLEDGE PROOF SYSTEM FOR STACK-BASED VIRTUAL MACHINE PROGRAM

(71) Applicant: Gwangju Institute of Science and Technology, Gwangju (KR)

(72) Inventors: Je Hyuk JANG, Gwangju (KR); Heung No LEE, Gwangju (KR)

(73) Assignee: Gwangju Institute of Science and Technology, Gwangju (KR)

(21) Appl. No.: 18/070,497

(22) Filed: Nov. 29, 2022

(30) Foreign Application Priority Data
Feb. 11, 2022 (KR) 10-2022-0018393

(51) Int. Cl. H04L 9/32; H04L 9/30

(52) U.S. Cl. CPC H04L 9/3218; H04L 9/3093; G06F 2009/45587

(57) ABSTRACT

The present invention relates to a zero-knowledge proof technique, and more particularly, to a succinct and non-interactive zero-knowledge proof system for a universal stack machine program, and a method thereof. According to an embodiment of the present invention, when a universal and concise zero-knowledge SNARK is applied to a smart contract of a blockchain, the transaction processing speed may be increased only for the operation proof of the stack machine program by using the simple structural features of a stack machine.

### BACKGROUND OF THE INVENTION

### Field of the Invention

The present invention relates to a zero-knowledge proof technique, and more particularly, to a succinct and non-interactive zero-knowledge proof system for a universal stack-based virtual machine program, and a method thereof.

### Background of the Related Art

The zero-knowledge proof (ZKP) technique is a set of algorithms used by a prover to prove to a verifier that a statement including sensitive information is true without opening the sensitive information. Describing in detail, the prover himself or herself proves that the asserted statement is true by using sensitive information only the prover knows, and generates and transfers only zero-knowledge proof about that the process is correct to the verifier, and the verifier may determine whether the statement is true or false by verifying the zero-knowledge proof without securing sensitive information. An example of utilizing the zero-knowledge proof technique is authenticating that ‘only that person can do it’ by showing that a self-authentication process is correct, instead of presenting personal information data that can prove identity. Another example of utilizing the zero-knowledge proof technique is proving that an execution result of a stack-based virtual machine (hereinafter, stack machine) program is correct, and here, input data used for execution of the stack machine program may be sensitive information.

Recently, a zero-Knowledge SNARK (zk-SNARK, Zero-Knowledge Succinct Non-Interactive Argument of Knowledge) technique that efficiently performs zero-knowledge proof by making a non-interactive and succinct proof condition in a proof process is spotlighted. In the zero-knowledge SNARK (zk-SNARK) technique, communication between a prover and a verifier is not required, the length of zero-knowledge proof is short, the amount of proof computation is small, and the amount of verification computation is smaller than the amount of computation required for direct execution of a statement.

In order to provide cryptographic security, the zero-knowledge SNARK (zk-SNARK) calls and uses variables commonly required for the operation of a proof algorithm and a verification algorithm from a file called Reference String (RS). Variables of the reference string (RS) are encrypted and generated by a trustworthy third party through a Trusted Setup procedure. Since the trusted setup needs a trustworthy third party and requires a trustworthy procedure, it consumes a great deal of cost and time.

The zero-knowledge SNARK (zk-SNARK) may be divided into a circuit-specific zero-knowledge SNARK that requires a new trusted setup of variables (RS) whenever a statement or a program is changed according to the structural features of the variables (RS), and a universal zero-knowledge SNARK that may reuse previously used variables (RS) although a statement or a program is changed. Generally, when the statement or the program is fixed, the circuit-specific zero-knowledge SNARK is much more succinct than the universal zero-knowledge SNARK. On the contrary, since new variables (RS) should be generated when the statement or the program is changed in the circuit-specific zero-knowledge SNARK, a universal zero-knowledge SNARK (zk-SNARK) having longer proof and slower verification should be used.

(Patent Document 0001) 1. Korean Patent Publication No. 10-1799517 “Authentication Server and Method” (Publication Date: Apr. 18, 2017)

### SUMMARY OF THE INVENTION

Therefore, the present invention has been made in view of the above problems, and it is an object of the present invention to provide a universal zero-knowledge SNARK proof system and a method thereof, which can be used to prove an execution result of a stack machine program in zero-knowledge proof.

The present invention provides a universal zero-knowledge SNARK proof system and a method thereof, which is universal and succinct only when a statement is a stack machine program.

The present invention provides a universal zero-knowledge SNARK proof system and a method thereof, which can generate and verify proof by integrating modules in an encrypted state without decryption.

According to one aspect of the present invention, there is provided a universal zero-knowledge SNARK proof system for a stack machine program.

The universal zero-knowledge SNARK proof system for a stack machine program according to an embodiment of the present invention comprises: a module generation unit for generating a module by transforming a predefined operation instruction code into a circuit polynomial; a module transform unit for integrating one or more modules; and a connection relation application unit for applying connection relation information of the modules.

According to another aspect of the present invention, there is provided a universal zero-knowledge SNARK proof method for a stack machine program, and a computer program executing the same.

The universal zero-knowledge SNARK proof method for a stack machine program and the computer program executing the same according to an embodiment of the present invention may include the steps of: generating a module by transforming a predefined operation instruction code into a circuit polynomial; integrating one or more modules; and applying connection relation information of the modules.

### BRIEF DESCRIPTION OF THE DRAWINGS

FIGS. 1 and 2 are views for explaining a universal zero-knowledge SNARK proof system for a stack machine program according to an embodiment of the present invention.

FIGS. 3 to 5 are views showing examples of modules generated in a universal zero-knowledge SNARK proof system for a stack machine program according to an embodiment of the present invention.

FIGS. 6 to 8 are views for explaining module transform of a universal zero-knowledge SNARK proof system for a stack machine program according to an embodiment of the present invention.

FIGS. 9 and 10 are views for explaining application of connection relation information of a universal zero-knowledge SNARK proof system 10 for a stack machine program according to an embodiment of the present invention.

FIG. 11 is a flowchart illustrating a universal zero-knowledge SNARK proof method for a stack machine program according to an embodiment of the present invention.

### DETAILED DESCRIPTION OF THE PREFERRED EMBODIMENT

Since the present invention can be diversely modified and may have various embodiments, specific embodiments are illustrated in the drawings and will be described in detail through the detailed description. However, it should be understood that this is not intended to limit the present invention to the specific embodiments, but to include all modifications, equivalents, and substitutes included in the spirit and scope of the present invention. When it is determined in describing the present invention that a detailed description of related known techniques may unnecessarily obscure the gist of the present invention, the detailed description will be omitted. In addition, singular expressions used in this specification and claims should be generally interpreted to mean “one or more” unless mentioned otherwise.

Hereinafter, preferred embodiments of the present invention will be described in detail with reference to the accompanying drawings, and in describing with reference to the accompanying drawings, the same reference numerals are given to the same or corresponding components, and duplicated description thereof will be omitted.

Zero-knowledge SNARK (zk-SNARK) is the abbreviation of ‘zero-knowledge Succinct Non-interactive Argument of Knowledge’, and it is a technique modified to apply existing zero-knowledge proof in a more succinct and non-interactive environment.

The zero-knowledge SNARK (zk-SNARK) may be divided into a circuit-specific zero-knowledge SNARK that requires a new trusted setup of variables (RS) whenever a statement or a program is changed according to the structural features of the variables (RS), and a universal zero-knowledge SNARK that may reuse previously used variables (RS) although a statement or a program is changed. Generally, when the statement or the program is fixed, the circuit-specific zero-knowledge SNARK is much more succinct than the universal zero-knowledge SNARK. However, since new variables (RS) should be generated when the statement or the program is changed in the circuit-specific zero-knowledge SNARK, the universal zero-knowledge SNARK (zk-SNARK) that has longer proof and slower verification is mainly used.

The present invention provides a succinct universal zk-SNARK for stack machines. The present invention may improve blockchain transaction processing speed only for the stack machines as it is more succinct than general universal zk-SNARKs.

A stack machine is an emulator that virtualizes a computer system as a stack-based virtual machine. The stack machine has a simple structure in which operation instructions are executed sequentially. A program that can be executed in such a stack machine is a smart contract.

The present invention may effectively verify the content of the smart contract.

The blockchain performs verification on smart contracts in every block every time. At this point, when verification on the content of the smart contract is replaced with verification on proof of the zero-knowledge SNARK (zk-SNARK), anonymity and processing speed may be improved greatly. However, as a smart contract program may vary according to the user, the circuit-specific zk-SNARK is not suitable.

The smart contract is a simple structure in which simple operation instruction codes (opcodes) are executed sequentially. However, in a stack machine, there may be numerous smart contracts that have various combinations of operation instruction codes. It is not easy to set up all the smart contracts, as many as the number of cases, as a variable (RS).

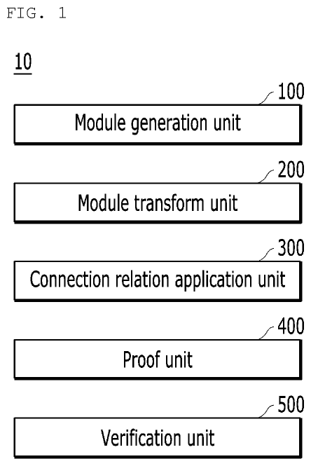

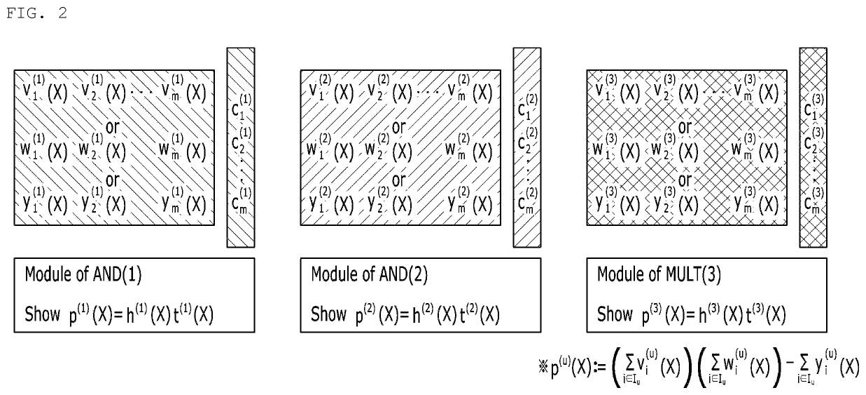

FIGS. 1 and 2 are views for explaining a universal zero-knowledge SNARK proof system for a stack machine program according to an embodiment of the present invention.

Referring to FIG. 1, a universal zero-knowledge SNARK proof system 10 for a stack machine program includes a module generation unit 100, a module transform unit 200, a connection relation application unit 300, a proof unit 400, and a verification unit 500.

The universal zero-knowledge SNARK proof system 10 for a stack machine program generates a setup file by performing a trusted setup on the variables (Reference string, RS) of the stack machine program.

The setup file is a reference file used by both a prover and a verifier so that the non-interactive system may be secure. The universal zero-knowledge SNARK proof system 10 for a stack machine program encrypts information on the stack machine program and variables RS such as security parameters or the like, and stores them in the setup file.

The stack machine has an instruction set that defines operation instruction codes (opcodes) in advance. For example, the instruction set defines the operation instruction codes (opcodes) in the form of “Instruction set:={ADD, MULT, EQUAL, AND, OR, NAND, . . . }”.

Although an actual stack machine program has much more operations and is complicated, a simple BITWISE-AND operation instruction configured of two AND operation instructions and one MULT operation instruction will be described in the present invention as an example for better understanding.

In the present invention, all operation instruction codes (opcodes) defined in the instruction set of a stack machine are transformed into circuit polynomials to be used for zero-knowledge proof, and this is referred to as a module.

FIG. 2 is a view showing an example of performing a proof used in a conventional zero-knowledge proof.

As shown in the example of FIG. 2, in the prior art, a stack machine program is proved to be true by proving that the operation of each module is true and proving all connection relations. A circuit polynomial of a stack machine program is modeled as a one-dimensional permutation of the module. Since it is proved using modules corresponding to three operation instruction codes (opcodes) and all connection relations of each module are proved as shown in FIG. 2, a total of four proofs should be performed for the three operation instruction codes (opcodes). In the prior art, as the operation and connection relation of each module are proved to be true individually, the more complicated the stack machine program, the larger the size of the proof, and the more complicated the verification process.

On the contrary, in the universal zero-knowledge SNARK proof system 10 for a stack machine program, the operations and connection relation of all modules used in the stack machine program may be proved to be true at once.

In the present invention, an array of instructions of a stack machine program is defined as a program array, and an operation instruction array is defined as information in which only the operation instructions, excluding the value, are arranged.

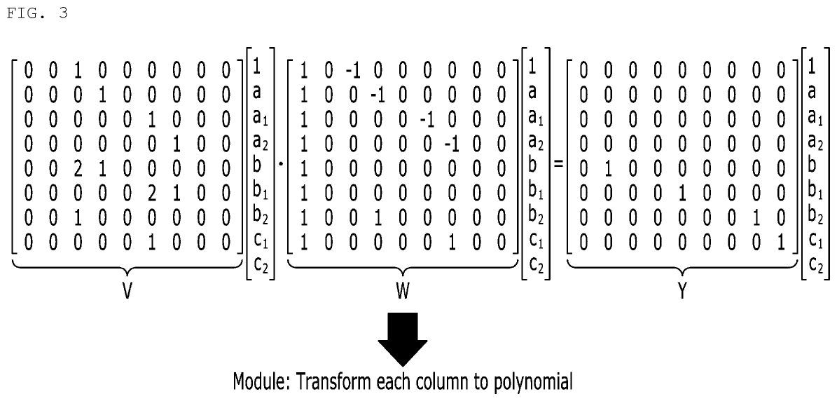

FIGS. 3 to 5 are views showing examples of modules generated in a universal zero-knowledge SNARK proof system for a stack machine program according to an embodiment of the present invention.

FIG. 3 is a view showing an example of generating a circuit polynomial of a QAP structure, by the module generation unit 100, from the BITWISE-AND operation instruction code (opcode) used in the example of FIG. 2.

Referring to the example of FIG. 3, the module generation unit 100 generates a module by transforming the columns of each of three matrices (V, W, Y) included in the QAP circuit polynomial of a BITWISE-AND operation instruction code (opcode) into a polynomial using FFT or NTT. For example, polynomial v₃(X) in the third column of matrix V is generated by interpolating eight discrete data tuples {((ω₈)⁰, 1), ((ω₈)⁴, 2), ((ω₈)⁶, 1)} ∪ {((ω₈)^{k}, 0)}_{k=1,k≠4,6}⁷. At this point, (ωₙ)^{k} is the root of the circuit polynomial, and is a certain number having a property as shown in [Equation 1].

Roots of circuit polynomial={ωₙ^{k}}ₖ₌₀ⁿ⁻¹

(ωₙ)ⁿ⁼¹,Σₖ₌₀ⁿ⁻¹(ωₙ)^{k}=0 [Equation 1]

A module of a correctly created QAP structure has a characteristic as shown in [Equation 2]. Only a prover who knows secret information may find h(x) in [Equation 2].

(Σᵢcᵢvᵢ(X))·(Σᵢcᵢwᵢ(X))−(Σᵢcᵢyᵢ(X))=t(X)h(X) [Equation 2]

A necessary and sufficient condition for the module to be correct is that h(X) satisfying [Equation 2] exists. Here, vᵢ(x), wᵢ(x), yᵢ(x) are polynomials of the i-th column of V, W, and Y, respectively, c:=[1, a, a₁, a₁, a₂, b, b₁, b₂, c₁, c₂] is an array of wire variables used in the module, cᵢ is the i-th wire variable of c, and t(X)=Π₍ₖ₌₀₎⁽ⁿ⁻¹⁾(X−ωₙ)^{k} is satisfied.

The module generation unit 100 may generate a module by transforming all operation instruction codes (opcodes) defined in the instruction set of the stack machine into a circuit polynomial that will be used for zero-knowledge proof. The module generation unit 100 may generate a module by transforming a predefined operation instruction code (opcode) into a circuit polynomial. That is, a transformed circuit polynomial is a module.

The module generation unit 100 may generate individual modules on the basis of each circuit polynomial corresponding to each operation instruction code.

The module generation unit 100 uses polynomial interpolation when an operation instruction code (opcode) is transformed into a circuit polynomial. For example, the module generation unit 100 may generate a module by transforming a circuit polynomial by utilizing a Fast Fourier transform (FFT) when performing the polynomial interpolation. The module generation unit 100 may utilize a fast Fourier transform (FFT) method in the real domain, and a number-theoretic transform (NTT) in a finite field domain.

The module generation unit 100 may transform each operation instruction code (opcode) into a circuit polynomial, encrypt and record the circuit polynomial in the variable (RS), and generate a setup file.

The module generation unit 100 may use partially homomorphic encryption when it encrypts a circuit polynomial. The partially homomorphic encryption is encryption in which an encryption operation has linearity with respect to one among addition and multiplication operations.

The module generation unit 100 may record all modules of the stack machine program in the variable (RS). Since the module generation unit 100 includes all modules in the variable (RS), it does not need to create a new setup file even in various combinations of the stack machine program.

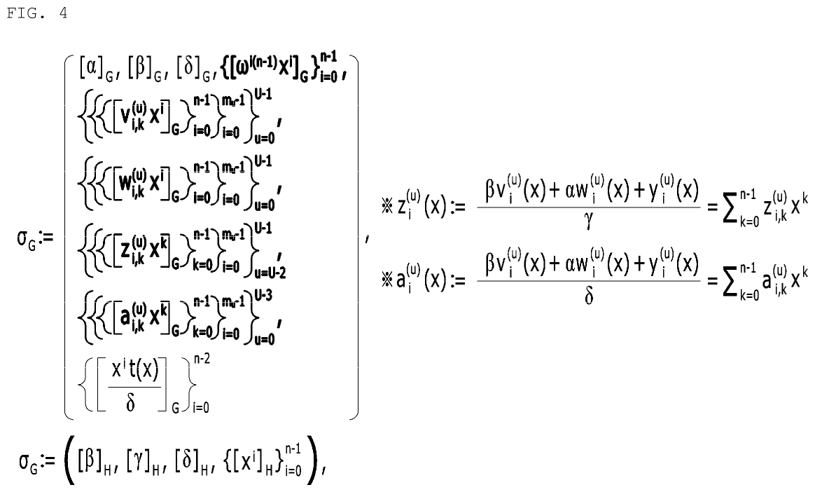

FIG. 4 is a view showing an example of a variable (RS) setup file created by the module generation unit 100.

Referring to FIG. 4, operation symbols [?]_{G} and [?]_{H} denote partially homomorphic encryption operations in which the generators are G and H, respectively.

Referring to FIG. 4, the module generation unit 100 may allow a trustworthy third party to set security parameters α, β, γ, δ, x.

Referring to FIG. 4, v_{i,k}^{(u)}, w_{i,k}^{(u)}, y_{i,k}^{(u)}, a_{i,k}^{(u)}, z_{i,k}^{(u)} are coefficients of k-order terms of polynomials vᵢ^{(u)}(X), wᵢ^{(u)}(X), yᵢ^{(u)}(X), aᵢ^{(u)}(X), zᵢ^{(u)}(X), respectively. vᵢ^{(u)}(X), wᵢ^{(u)}(X), yᵢ^{(u)}(X) are polynomials of the i-th columns of circuit matrices V, W, Y of the u-th module. aᵢ^{(u)}(X) and zᵢ^{(u)}(X) may be defined as shown in [Equation 3] and [Equation 4], respectively.

$${a}_{i}^{( u )} ( X ) := \frac{β {v}_{i}^{( u )} ( X ) + {αw}_{i}^{( u )} ( X ) + {Y}_{i}^{( u )} ( X )}{δ} \qquad [ Equation 3 ]$$

$${z}_{i}^{( u )} ( X ) := \frac{β {v}_{i}^{( u )} ( X ) + {αw}_{i}^{( u )} ( X ) + {Y}_{i}^{( u )} ( X )}{γ} \qquad [ Equation 4 ]$$

The module generation unit 100 may extract a program array and an operation instruction array from a stack machine program configured of operation instruction codes (opcodes).

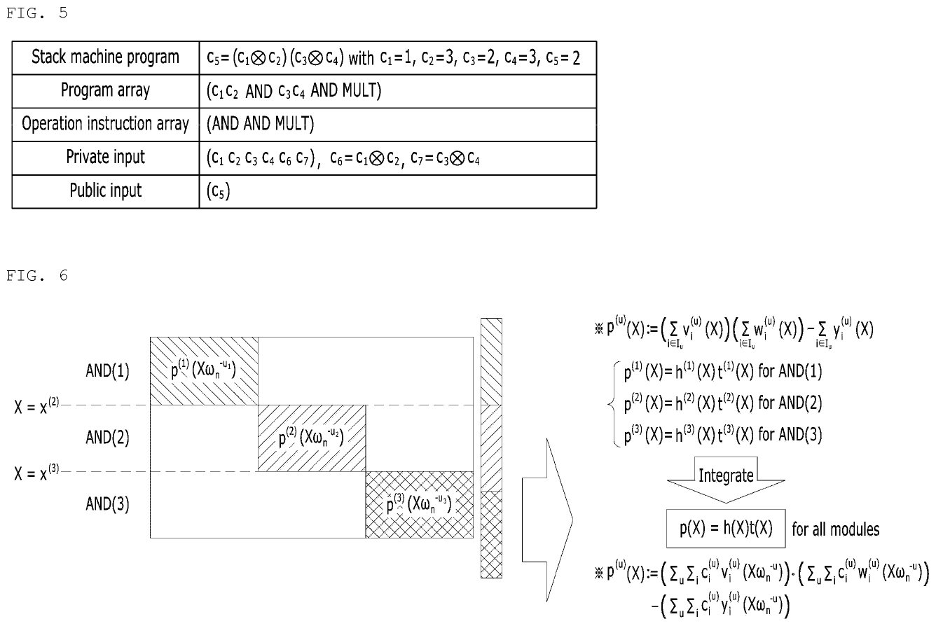

Referring to the example of FIG. 5, the module generation unit 100 may extract a program array (c₁, c₂ AND c₃, c₄ AND MULT) and an operation instruction array (AND AND MULT) from an example of a stack machine program c₅=(c₁⊗c₂)(c₃⊗c₄) with c₁=1, c₂=3, c₃=2, c₄=3, c₅=2 that uses two BITWISE-AND operation instructions and one MULT operation instruction.

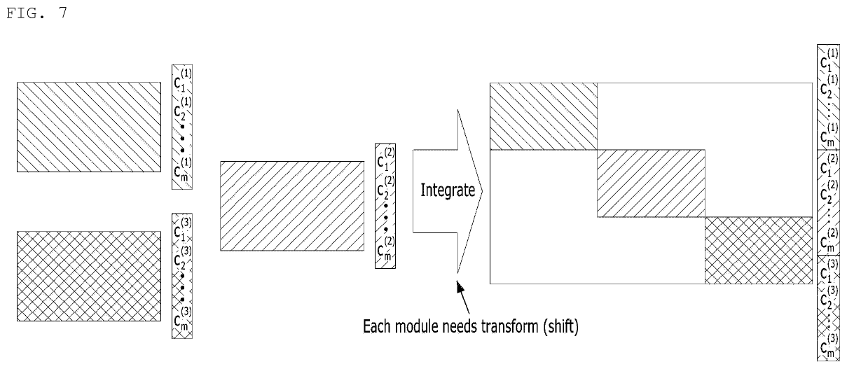

FIGS. 6 to 8 are views for explaining module transform of a universal zero-knowledge SNARK proof system for a stack machine program according to an embodiment of the present invention.

A conventional zero-knowledge SNARK proof system should prove that the modules of two BITWISE-AND operation instruction codes and one MULT operation instruction code (opcode) are true in order to prove contract of the stack machine of the example shown in FIG. 3.

Referring to FIG. 6, the module transform unit 200 may integrate the modules generated in correspondence to each operation instruction code.

Describing the example of FIG. 6 in detail, the module transform unit 200 may integrate all modules p^{(u)}(X):=(Σᵢcᵢ^{(u)}vᵢ^{(u)})(Σᵢcᵢ^{(u)}wᵢ^{(u)})−(Σᵢcᵢ^{(u)}yᵢ^{(u)}) for module numbers u=1, 2, and 3. The integrated circuit polynomial is as shown in [Equation 5].

p(X):=(ΣᵤΣᵢcᵢ^{(u)}vᵢ^{(u)}(Xωₙ^{-u}))·(ΣᵤΣᵢcᵢ^{(u)}wᵢ^{(u)}(Xωₙ^{-u}))−ΣᵤΣᵢcᵢ^{(u)}yᵢ^{(u)}(Xωₙ^{-u}) [Equation 5]

Through the equation, the prover may prove that h(X) satisfying p(X)=t(X)h(X) is known.

On the contrary, in the prior art, when module p^{(u)}(X):=(Σᵢcᵢ^{(u)}vᵢ^{(u)}(X))(Σᵢcᵢ^{(u)}wᵢ^{(u)}(X))−(Σᵢcᵢ^{(u)}yᵢ^{(u)}(X)) is given for module numbers u=1, 2, 3, the prover proves that all h^{(u)}(X) satisfying p^{(u)}(X)=t(X)h^{(u)}(X) are known should be proved for u=1, 2, 3.

The universal zero-knowledge SNARK proof system 10 for a stack machine program may generate one piece of proof by integrating the modules.

The universal zero-knowledge SNARK proof system 10 for a stack machine program may prove zero-knowledge by integrating modules respectively corresponding to each operation instruction code, referring to the connection relation of the modules from a variable (RS) and applying the connection relation, and then generating one piece of proof. For example, the universal zero-knowledge SNARK proof system 10 for a stack machine program proves zero-knowledge by generating one piece of proof by integrating three modules and one connection relation information in a stack machine program including three operation instruction codes. The connection relation information may include all connection relation information of the operation instruction codes.

That is, according to an embodiment, although the conventional technique proves four times, the universal zero-knowledge SNARK proof system 10 for a stack machine program only needs to perform verification once using one piece of proof. Although the example described in the present invention has three operations, since an actual stack machine program has a much larger number of operations, the conventional technique has a long length of proof, and should perform verification as many times as the length of proof.

The universal zero-knowledge SNARK proof system 10 for a stack machine program may generate and verify one piece of proof by referring to and integrating modules corresponding to the operation instruction codes and connection information of the operation instructions from the variable (RS).

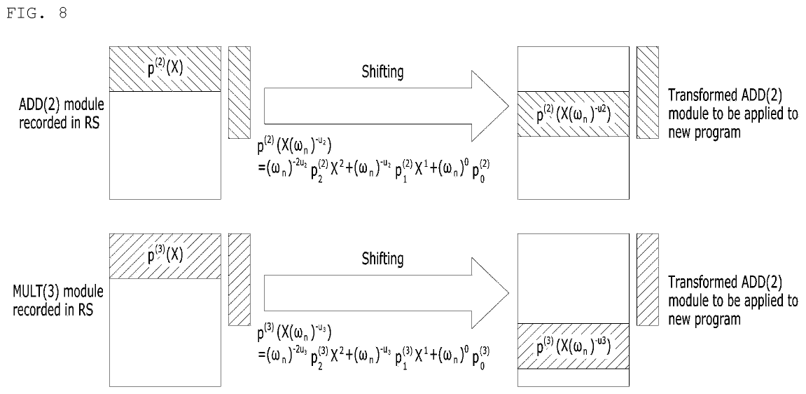

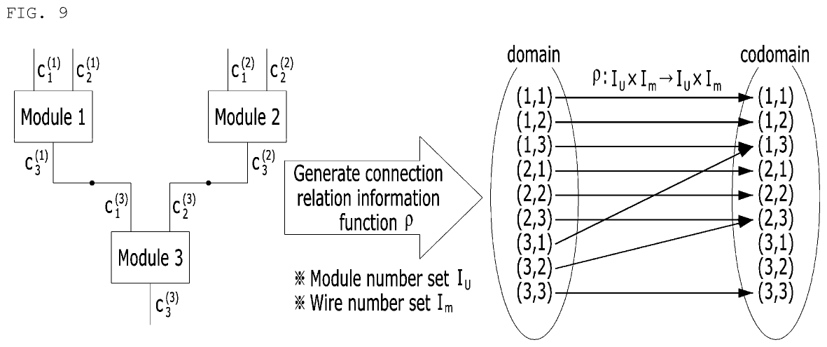

FIGS. 7 and 8 are views showing examples of moving and transforming a module of a simple stack machine program by the module transform unit 200 according to an embodiment of the present invention.

According to an embodiment, the universal zero-knowledge SNARK proof system 10 for a stack machine program requires a transform (shift) process for moving modules in order to connect respective modules to integrate into one piece of proof.

The module transform unit 200 may integrate modules of one or more operation instruction codes (opcodes) through a transform process of moving the modules. The module transform unit 200 may integrate individual modules corresponding to the operation instruction codes according to the operation instruction array.

Since each module is stored in the setup file as a variable (RS), and the value is stored after being encrypted, it is difficult to perform the transform (shift) process. Describing in detail, it is not that the original form of a module, which is a circuit polynomial, is stored in the setup file, but a result of calculation performed by inputting a secret value into the polynomial is stored after being encrypted. For example, as a result of calculation performed using a certain secret value x in polynomial p(X), a form of [P(x)]_{G} encrypting P(X) is stored. When the module is p(X):=p₂X²+P₁X+P₀, it is encrypted and stored as [P(x)]_{G}:=p₂[x²]_{G}+p₁[x]+p₀. That is, the module is not stored in the variable (RS) in the original form of a circuit polynomial, but is stored in an encrypted form, and although an encrypted output value is open, no one may confirm the original input value before the encryption. Therefore, in the prior art, since the input value before the encryption is unknown, the module cannot be modified or transformed (shifted).

However, referring to FIG. 7, the module transform unit 200 may integrate the modules by transforming (shifting) the modules using a shifting property. For example, the module transform unit 200 may transform encrypted [p(x)]_{G} into [p(X−a^{u})]_{G} for any values a and u.

Since the module generation unit 100 has transformed the circuit polynomial by using the fast Fourier transform (FFT), the module transform unit 200 may transform (shift) the module using a shifting property.

The module transform unit 200 may transform (shift) the module encrypted as shown in the example of [Equation 6] without decryption by applying a shifting property.

p(X):=p₂X²+p₁X+p₀

p(Xωₙ^{-u}):=ωₙ⁻²p₂X²+ωₙ⁻¹p₁X+wₙ⁰p₀

[p(ωₙ⁻¹)]_{G}:=ωₙ⁻²p₂[x²]_{G}+ωₙ⁻¹p₁[x¹]_{G}+wₙ⁰p₀[x⁰]_{G} [Equation 6]

Referring to the example of FIG. 8, the module transform unit 200 may performs a transform (shift) process using a shifting property to integrate the modules recorded in the variable (RS) to generate one piece of proof. For example, the module transform unit 200 may transform module p⁽²⁾(X) into p⁽²⁾(x(ωₙ)^{-u}^{₂})=(ωₙ)^{-2u}^{₂}p₂⁽²⁾x²(ωₙ)^{-u}^{₂}p₁⁽²⁾X¹+(ωₙ)⁰p₀⁽²⁾, and transform module p⁽³⁾(X) into p⁽³⁾(X(ωₙ)^{-u}^{₃})=(ωₙ)^{-2u}^{₃}p₂⁽³⁾X²+(ωₙ.)^{-u}^{₃}p₁⁽³⁾X¹+(ωₙ)⁰p₀⁽³⁾. At this point, positive integer k in the root ωₙ^{-k} used for transform of each module is determined to correspond to the order of the operation instruction array of the stack machine program.

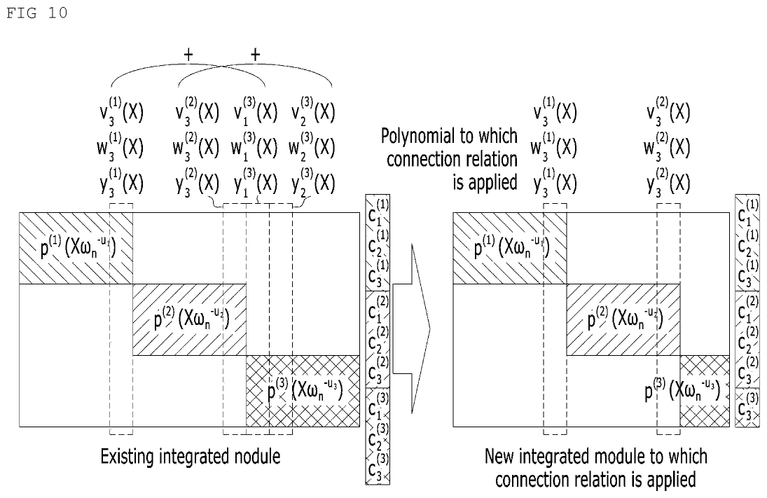

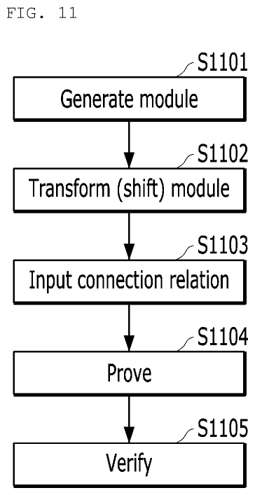

FIGS. 9 and 10 are views for explaining application of connection relation information of a universal zero-knowledge SNARK proof system 10 for a stack machine program according to an embodiment of the present invention.

The connection relation application unit 300 may apply the connection relation information to the integrated module.

The connection relation application unit 300 uses the program array and the operation instruction array extracted by the module generation unit 100 from the stack machine program configured of operation instruction codes (opcodes). Referring to the example of FIG. 6 again, the module generation unit 100 may use the program array (cᵢ, c₂ AND c₃, c₄ AND MULT) and the operation instruction array (AND AND MULT) extracted from an example of a stack machine program c₅=(c₁└c₂)(c₃└c₄) with c₁=1, c₂=3, c₃=2, c₄=3, c₅=2 that uses two BITWISE-AND operation instructions and one MULT operation instruction.

The connection relation application unit 300 may generate connection relation information between the input wire and the output wire of each module in the form of function ρ(u,i) defined in [Equation 7] with reference to the program array.

ρ:I_{U}×Iₘ→I_{U×I}_{ₘ}

I_{U}:=1,2, . . . ,U

Iₘ:=1,2, . . . ,m [Equation 7]

U: Number of used modules

m: Maximum value of the number of module wire variables

When wire cᵢ^{(u)} is the input wire of a certain module and is connected to output wire cᵢ^{(k)} of another module, ρ(u,i)=(k,j), otherwise ρ(u,i)=(u,i).

Describing ρ(u,i) in detail with reference to FIG. 9, in the example of a stack machine program in which three modules are used, since output wire c₃⁽¹⁾ of a first module and output wire c₃⁽²⁾ of a second module are connected to input wires cᵢ⁽³⁾ and c₂⁽³⁾ of a third module, ρ(3, 1)=(1, 1). Accordingly, ρ(3, 2)=(2, 1), and for all (u, i) in which (u,i)≠(3, 1) and (u,i)≠(3, 2), ρ(u, i)=(u, i).

The connection relation application unit 300 generates a new integrated module by applying the connection relation information function ρ(u,i) to the polynomial of the existing integrated module.

The wire array of the new integrated module generated by the connection relation application unit 300 is as shown in [Equation 8].

Wire array of new integrated module c:=[cᵢ^{(u)}]_{(u,i)∈img(ρ)} [Equation 8]

cᵢ^{(u)}: Wire array of existing integrated module

img(ρ): Range of function ρ (image)

The polynomial of the new integrated module generated by the connection relation application unit 300 is as shown in [Equation 9]. When vᵢ^{(u)}(X) and wᵢ^{(u)}(X), yᵢ^{(u)}(X) are polynomials transformed (shifted) from an existing integrated module for all (u,i)∈dom(ρ), the polynomial of the new integrated module is as shown in [Equation 9] for all (k,j)∈dom(ρ).

vⱼ^{(k)}(X)←Σ_{(u,i)∈ρ}_{^{−1}}_{({(k,j)})}vᵤ⁽ⁱ⁾(X)

wⱼ^{(k)}(X)←Σ_{(u,i)∈ρ}_{^{−1}}_{({(k,j)})}wᵤ⁽ⁱ⁾(X)

yⱼ^{(k)}(X)←Σ_{(u,i)∈ρ}_{^{−1}}_{({(k,j)})}yᵤ⁽ⁱ⁾(X) [Equation 9]

dom(ρ): Domain of function ρ

FIG. 10 is a view showing an example of generating a new integrated module by applying a connection relation to an existing integrated module, by the connection relation application unit 300, for the stack machine program and the connection relation information function p used as the example of FIG. 9.

Referring to the example of FIG. 10, the number of polynomials and wires of the new integrated module generated by the connection relation application unit 300 may be smaller than the number of polynomials and wires of the existing integrated module. This is since that the connection relation application unit 300 may generate one polynomial of the new integrated module by adding all polynomials having a connection relation with each other in the existing integrated module with reference to ρ.

The proof unit 400 may generate one piece of proof that can be proved at once by integrating all the modules and connection relation information.

Most of the zero-knowledge SNARKs (zk-SNARKs) use an Elliptic Curve Cryptography (ECC) algorithm as an encryption method. The Elliptic Curve Cryptography (ECC) algorithm has linearity.

Since the universal zero-knowledge SNARK proof system 10 for a stack machine program uses a polynomial interpolation method using Fourier transform, module transform and application of connection relation information may also be linear operations.

Since the Elliptic Curve Cryptography (ECC) has linearity, module transform is a linear operation, and application of connection relation information is also a linear operation, and therefore, the universal zero-knowledge SNARK proof system 10 for a stack machine program may perform module transform and apply connection relation information without decryption using the linearity.

The universal zero-knowledge SNARK proof system 10 for a stack machine program may transform (shift) and integrate modules, and apply polynomials having a connection relation in a way of adding, without decryption, using Elliptic Curve Cryptography (ECC).

The proof unit 400 may generate proof for zero-knowledge proof. The proof unit 400 may generate one piece of zero-knowledge proof by applying transform of each module and connection relation information. Describing in detail, the proof unit 400 may prove zero-knowledge and generate zero-knowledge proof using the stack machine program, the setup file in which variables are encrypted, a private input value of the stack machine program, and a public output value of the stack machine program.

The proof unit 400 first generates random integers r and s of private security parameters, and then creates three proof files [A]_{G}, [B]_{G}, [C]_{G} that prove the truth. The three proof files are included in one proof set (SET).

$$[ Equation 10 ]$$

$${[ A ]}_{G} := {[ α ]}_{G} + {\sum }_{( u = 0 )}^{( U - 1 )} {\sum }_{( i = 0 )}^{( m - 1 )} {\sum }_{( k = 0 )}^{( n - 1 )} {c}_{i}^{( u )} {v}_{i , k}^{( u )} {{ω}^{- u k} [ {x}^{k} ]}_{G} + {r [ δ ]}_{G}$$

$${[ B ]}_{H} := {[ β ]}_{H} + {\sum }_{( u = 0 )}^{( U - 1 )} {\sum }_{( i = 0 )}^{( m - 1 )} {\sum }_{( k = 0 )}^{( n - 1 )} {c}_{i}^{( u )} {w}_{i , k}^{( u )} {{ω}_{n}^{- uk} [ {x}^{k} ]}_{G} + {s [ δ ]}_{H}$$

$${[ C ]}_{G} := {\sum }_{( u = 0 )}^{( U - 3 )} {\sum }_{( i = 0 )}^{( m - 1 )} {\sum }_{( k = 0 )}^{( n - 1 )} {c}_{i}^{( u )} {{ω}_{n}^{- uk} [ {a}_{( i . k )}^{( u )} {x}^{k} ]}_{G} + {\sum }_{k = 0}^{n - 2} {{h}_{k} [ \frac{{x}^{k} t ( x )}{δ} ]}_{G} + {s [ A ]}_{G} + {r [ B ]}_{G} - r {s [ δ ]}_{G}$$

The verification unit 500 verifies the generated zero-knowledge proof. Describing in detail, the verification unit 500 may verify whether the zero-knowledge proof is true or false by using the stack machine program, the setup file in which variables (RS) are encrypted, and the public output value of the stack machine program.

The verification unit 500 first confirms whether all the data of the generated proof are points on the elliptic curve, and then calculates LHS=[A]_{G}·[B]H using the proof, where the notation ·represents the pairing function of two group elements.

The verification unit 500 calculates RHS of [Equation 10] using the proof and the variable (RS).

RHS:=[α]_{G}·[β]_{H}+[C]_{G}·[δ]_{H}+(Σ_{(u=U-2)}^{(U-1)}Σ₍ᵢ₌₀₎^{(m-1)}Σ₍ₖ₌₀₎⁽ⁿ⁻¹⁾cᵢ^{(u)}ωₙ^{-uk}[z_{i,k}^{(u)}x^{k}]_{G})·[γ]_{H} [Equation 11]

The verification unit 500 may determine the zero-knowledge proof as true when LHS=RHS is satisfied, and may determine the zero-knowledge proof as false when the equal sign is not satisfied.

FIG. 11 is a flowchart illustrating a universal zero-knowledge SNARK proof method for a stack machine program according to an embodiment of the present invention. Although the process described below is a process performed by each functional unit constituting the universal zero-knowledge SNARK proof system for a stack machine program at each step, the subject of each step is generally referred to as a universal zero-knowledge SNARK proof system for concise and clear explanation of the present invention.

Referring to FIG. 11, at step S1101, the universal zero-knowledge SNARK proof system 10 for a stack machine program generates each operation instruction code as a module. For example, the universal zero-knowledge SNARK proof system 10 for a stack machine program may generate a module by transforming each operation instruction code into a circuit polynomial using a polynomial interpolation method.

At step S1102, the universal zero-knowledge SNARK proof system 10 for a stack machine program may integrate modules. For example, a universal zero-knowledge SNARK proof system 10 for a stack machine program may integrate by transforming (shifting) individual modules.

At step S1103, the universal zero-knowledge SNARK proof system 10 for a stack machine program may apply connection relation information of each module. For example, the universal zero-knowledge SNARK proof system 10 for a stack machine program may generate an optimized new integrated module by integrating individual modules corresponding to each operation instruction code and applying the connection relation information.

At step S1104, the universal zero-knowledge SNARK proof system 10 for a stack machine program generates one piece of zero-knowledge proof by applying transform of each module and connection relation information. Describing in detail, the universal zero-knowledge SNARK proof system 10 for a stack machine program prove zero-knowledge and generate zero-knowledge proof using the stack machine program, the setup file in which variables are encrypted, a private input value of the stack machine program, and a public output value of the stack machine program.

At step S1105, the universal zero-knowledge SNARK proof system 10 for a stack machine program verifies the zero-knowledge proof. Describing in detail, the universal zero-knowledge SNARK proof system 10 for a stack machine program may verify whether the zero-knowledge proof is true or false by using the stack machine program, the setup file in which variables (RS) are encrypted, and the public output value of the stack machine program.

The universal zero-knowledge SNARK proof method for a stack machine program described above may be implemented as a computer-readable code on a computer-readable medium. The computer-readable recording medium may be, for example, a mobile recording medium (CD, DVD, Blu-ray disk, USB storage device, mobile hard disk) or a fixed recording medium (ROM, RAM, computer-equipped hard disk). The computer program recorded on the computer-readable recording medium may be transmitted to another computing device through a network such as the Internet or the like and installed in another computing device, and therefore may be used in another computing device.

According to an embodiment of the present invention, when a universal and concise zero-knowledge SNARK is applied to a smart contract of a blockchain, the transaction processing speed may be increased only for the operation proof of the stack machine program by using the simple structural features of a stack machine.

In addition, according to an embodiment of the present invention, an encrypted module can be transformed without decryption by using linearity of each module.

In addition, according to an embodiment of the present invention, connection relation information between modules of a new stack machine program may be applied after being integrated without decryption using linearity.

Although all the components configuring the embodiments of the present invention are described as being combined in one piece or operating in combination, the technical spirit of the present invention is not necessarily limited to the embodiments. That is, within the scope of the objects of the present invention, all the components may operate by selectively combining one or more.

Although the operations are shown in a particular order in the drawings, it should not be understood that the operations should be performed in a specific order or a sequential order as shown in the drawings or all the operations shown in the drawings should be performed to obtain a desired result. In a specific situation, multitasking and parallel processing may be advantageous. Moreover, separation of the various components in the embodiments described above should not be construed as being necessarily required, and it should be understood that the described program components and systems may be generally integrated together into a single software product or packaged into a plurality of software products.

Until now, the present invention has been described focusing on the embodiments thereof. Those skilled in the art will understand that the present invention can be implemented in a modified form without departing from the essential characteristics of the present invention. Therefore, the disclosed embodiments should be considered in an illustrative viewpoint rather than a restrictive viewpoint. The scope of the present invention is shown in the claims rather than the above description, and all differences within the scope equivalent thereto should be construed as being included in the present invention.

### DESCRIPTION OF SYMBOLS

10: Universal zero-Knowledge SNARK proof system for stack machine program
100: Module generation unit
200: Module transform unit
300: Connection relation application unit
400: Proof unit
500: Verification unit

What is claimed is:

1. A universal zero-knowledge SNARK proof system for a stack machine program, the system comprising:
a module generation unit for generating a module by transforming a predefined operation instruction code into a circuit polynomial;
a module transform unit for integrating one or more modules; and
a connection relation application unit for applying connection relation information of the modules.

2. The system according to claim 1, wherein the module generation unit generates an individual module as each circuit polynomial corresponding to the operation instruction code.

3. The system according to claim 2, wherein a setup file is created by encrypting the circuit polynomial.

4. The system according to claim 1, wherein the module transform unit integrates individual modules corresponding to the operation instruction codes according to an operation instruction array.

5. The system according to claim 1, wherein the connection relation application unit applies connection relation information between an input wire and an output wire of each module with reference to a program array.

6. The system according to claim 1, further comprising:
a proof unit for generating proof for zero knowledge proof; and
a verification unit for verifying the proof.

7. A universal zero-knowledge SNARK proof method for a stack machine program executed by a universal zero-knowledge SNARK proof system for the stack machine program, the method comprising the steps of:
generating a module by transforming a predefined operation instruction code into a circuit polynomial;
integrating one or more modules; and
applying connection relation information of the modules.

8. The method according to claim 7, wherein the step of generating a module by transforming a predefined operation instruction code into a circuit polynomial individually transforms the operation instruction code into the circuit polynomial.

9. The method according to claim 8, wherein a setup file is created by encrypting the circuit polynomial.

10. The method according to claim 7, wherein the step of integrating one or more modules integrates individual modules corresponding to the operation instruction codes according to an operation instruction array.

11. The method according to claim 7, wherein the step of applying connection relation information of the modules applies connection relation information between an input wire and an output wire of each module with reference to a program array.

12. The method according to claim 7, further comprising the steps of:
generating proof for zero knowledge proof; and
verifying the proof.

13. A computer program recorded in a computer-readable recording medium, for executing claim 1 of the universal zero-knowledge SNARK proof method for a stack machine program.
